(19) United States
(12) Patent Application Publication
(10) Pub. No.: US 2011/0192225 A1
(43) Pub. Date: Aug. 11, 2011

(54) method for the dnyanmically adapted recording of an angular velocity using a digital angular position transducer

(76) Inventors: Mark Damson, Stuttgart (DE); Tino Merkel, Schwieberdingen (DE); Daniel Raichle, Eberdingen-Nussdorf (DE)

(21) Appl. No.: 13/059,599

(22) PCT Filed: Aug. 10, 2009
(86) PCT No.: PCT/EP09/60336

§ 371 Date: Apr. 28, 2011

(30) Foreign Application Priority Data
Aug. 18, 2008 (DE) 102008041307.0

(51) Int. Cl. G01P 3/00

(52) U.S. Cl. 73/489

(57) ABSTRACT

A method and a device for recording angular velocity using a digital angular position transducer, for controlling an electric motor, for example. Instead of taking into account time-discrete changes directly in the form of step changes in the output signal, the recorded angular velocity change is taken into account only with an (increasing) proportion in the output. This permits a smoother curve in the case of not completely precise transducer wheels, whose imprecisions would otherwise lead to unnecessary reactions by the regulation. Large angular velocity changes, on the other hand, are reproduced directly, so as to take into account accelerations going along with them in an unaffected manner in the regulation.

### FIELD OF THE INVENTION

The present invention relates to the recordings of rotational velocity using a digital angular position transducer, which records the position of a transducer wheel.

### BACKGROUND INFORMATION

In order to record the rotational speed of a shaft, for instance, a shaft of an electric machine, a transducer wheel is connected to the shaft and the rotation is recorded by recording markings on the edge of the transducer wheel. The markings correspond to certain angular positions, so that the angular position transducer signal indicates the points in time at which angular positions exist, for instance, using a clock signal slope. Consequently, the angular position or the angular velocity is not measured directly, but is calculated from the time duration, between two points in time, which corresponds to two different successive angular positions. The current angular velocity is thus burdened by an error which comes about by imprecise positioning of the markings on the transducer wheel. If, for instance, the transducer wheel is not manufactured in a highly precise manner, or if the markings are deformed or soiled, angular position signals come about that are shifted in time, because of these errors, and in the course of the revolution they lead to a fluctuating present angular velocity, although the transducer wheel is actually being rotated at constant velocity.

The angular velocity signal is thus burdened with a noise which acts interferingly on the dynamics, particularly in the case of dynamic regulating processes. For example, in the case of electric machines or internal combustion engines, but particularly in the case of electric machines, that are used for driving a hybrid vehicle or an electric vehicle, the angular velocity has to be regulated in highly dynamic fashion at very short reaction times.

Averaging the angular velocity over a time period or over one or more revolutions would, in particular, remove the high-frequency components from the angular signal, which are required for the precise dynamic control. Consequently, the noise brought about by the transducer wheel imprecisions cannot be reduced by averaging without giving rise to serious disadvantages in the dynamics of the sensor signal.

German document DE 102 00 504 7088 A1 discusess a method for producing a simulated transducer curve when a marking gap occurs in a transducer disk. In this instance, an additional angular position sequence is extrapolated from the measuring angular position signals, in order to close the gap. The document essentially relates to the extrapolation of angular signals, and does not focus on recording angular velocities. The document particularly does not look at errors that are created by the erroneous arrangement of teeth, but relates to the closing of gaps that come about from completely missing markings of the transducer wheel.

German document DE 102 58 846 A1 discusess a device for recording rotational angles, which makes it possible to make a statement about the absolute angular position. Just as in the previously named document, in this document we shall not look in greater detail at an angular velocity signal error due to imprecisions in the transducer signal.

Consequently, in highly dynamic regulation processes, angular recording mechanisms, according to the related art, have the disadvantage that imprecisions in the transducer wheel lead to unnecessary regulating compensation processes. On the one hand, the unnecessary regulating compensation processes are disadvantageous since they are able to lead to critical peak currents, and on the other hand, an increased precision of the transducer wheel is directly linked to clearly higher costs and greater susceptibility to dirt and deformation.

### SUMMARY OF THE INVENTION

It is therefore an object of the exemplary embodiments and/or exemplary methods of the present invention to provide an angular recording mechanical system which makes possible a better regulating response, even in the case of dynamic processes.

The exemplary embodiments and/or exemplary methods of the present invention make possible a clear reduction in the error that comes about from imprecisions in the transducer wheel, at the same time, the dynamics not being reduced in response to speed changes. Consequently, one may also use more cost-effective angular transducers, having a transducer wheel that is encumbered with certain manufacturing tolerances. At the same time, the exemplary embodiments and/or exemplary methods of the present invention make possible the immediate recording of actual angular velocity changes, that occur because of an acceleration of the shaft, velocity changes being recorded in full measure and indirectly. Thus, the angular velocity is able to be regulated in highly dynamic fashion, without, however, triggering undesired regulating processes that come about owing to imprecisions in the transducer wheel (and not owing to angular velocity changes).

The concept on which the exemplary embodiments and/or exemplary methods of the present invention is based is not to pass on directly the temporally discrete angular position signals, or rather the angular velocities calculated from them. In the case of deviations between two successive recording points in time (which are associated with successive angular positions), the latter are not passed on directly as a new value in the form of a stair-like step change, but, according to the present invention, an angular velocity signal curve is output which rises or drops continuously between two successive angular positions, corresponding to the sign of the angular velocity difference. Consequently, the temporally discretely recorded angular velocity is reproduced, however, not as a sequence of discontinuous curves, but as a continuously rising or falling line.

In one particular specific embodiment, the angular velocity curve does not rise to the completely newly recorded angular velocity value, but only to a portion of that, which (is positive and) less than one. This specific embodiment may be combined with a threshold value, to which angular velocity changes are compared. At a velocity change below the threshold value, the velocity change is not completely passed on but only as a portion, and above the threshold value, the velocity change is passed on directly and completely as a rising or falling slope. Because of this, at low angular velocity changes, like the ones that take place owing to imprecisions in the transducer wheel, what happens is that velocity changes that are not actually taking place, and changes produced only by the transducer wheel, for one thing, are not indicated as step changes, and for another thing, are not indicated completely for the angular velocity regulation. At actual accelerations, at which the angular velocity change is above the threshold value, it is passed on at once and directly to the regulation, so that the measured instantaneous angular velocity is output, and the regulation is able to react in an accustomed manner to the angular velocity changes.

Therefore, in the case of angular recording, a value may be selected for the threshold value which corresponds to the usual fluctuations produced by transducer wheel imprecisions. Since the imprecisions cause an angular error in a direct manner, and do not refer directly to an angular velocity (and its error), the threshold value is provided referred to an angle in a constant manner, that is, it is, for instance, normalized to an angular velocity by division by the current speed. In other words, the threshold value may decrease with increasing rotational speed, since the threshold value is used for cutting out errors in the absolute angle recording, which at high rotational velocities have a greater effect on angular velocities than at low rotational velocities. The normalization may further be carried out by multiplication with the factor normalization rotational velocity/current rotational velocity, the normalization speed being able to be freely selected and being constant. At the same time, the threshold value should take into account the dynamic requirements of the regulation, and should be below a value that corresponds to velocity step changes that require a (quick) reaction of the regulator, that is, velocity step changes whose absolute amount lets one conclude what the actual acceleration is, and which are not only explained by transducer wheel errors or transducer wheel noise. Instead of normalizing the threshold value to the rotational velocity, the recorded velocity change may also be normalized (to a normalized velocity), and a constant threshold value (or threshold values as described further on) may be used.

Instead of deciding, in the light of a threshold value, whether the one or the other of the two abovementioned operating modes is being used, a (continuous) weighting method may also be used, in which the angular velocity change, attenuated per proportional factor and linear curve, is taken into account so much the less at the output of the angular velocity signal, the greater the recorded angular velocity change is, the weighting of the classically immediately direct reproduction of the angular velocity being increased all the more, the greater the angular velocity change. Moreover, two threshold values may be used for this, in an, angular velocity change below a first threshold value, the angular velocity signal that is output, only a proportional angular velocity change having a continuous (rising or falling) curve being used, whereas, above a second threshold value, exclusively the recorded angular velocity change having an influence directly and completely on the angular velocity signal that is output.

The output angular velocity signal is then used for the regulation.

The concept, on which the exemplary embodiments and/or exemplary methods of the present invention are based, is essentially that, at least at low angular velocity changes, the angular velocity change is not directly and completely passed on, but only as a portion, and may have a continuous rising or falling curve, and not in the form of a slope, as occurs in the case of angular signals having temporally discrete, i.e. angular-discrete angle recordings. Temporally discrete angular recording here designates recording mechanisms in which corresponding signals, especially time marks, are recorded only at certain angular positions, the time marks usually being reproduced as slope characteristics between two different levels within a temporally continuous signal, so that, because of the two levels used, this type of recording is also designated as digital angular recording. It is essential, however, that the angular recording does not take place continuously, so that at each (any) point in time an angular position is output, but rather only at individual angular positions. Because of the rotational motion, since the individual points in time are clearly linked to certain angular positions, the discrete angular recording, on which the present invention is based, may be regarded as being a time-discrete and also as an angularly discrete recording.

According to the exemplary embodiments and/or exemplary methods of the present invention, time durations between two of a plurality of angular positions are recorded, the angular velocity being ascertained from the angle covered divided by the associated time duration. According to the present invention, this is carried out at regular intervals, i.e. each time a certain angle sensor position is taken up which agrees with a corresponding signal feature, such as a slope. In order to ascertain angular velocities, a first point in time and a second point in time are recorded at which the particular angle sensor positions are taken up, the angular velocity being yielded by the angle covered divided by the elapsed time. In the same way, a second angular velocity is also recorded, which may be directly after the first angular velocity, so that the second angle sensor position obtained in the recording of the first angular velocity may be used again while ascertaining the second angular velocity. To ascertain the second angular velocity, the reaching of a third angle sensor position is recorded, in this case again the respective points in time being recorded from the time duration coming about thereby and the angular difference between the second and third angular position, the ratio of the angular difference and the time duration is able to be formed.

According to the related art, the second recorded angular velocity would be passed on to the regulation directly after its ascertainment, the regulation initiating regulating measures according to this naturally discontinuous change.

However, according to the exemplary embodiments and/or exemplary methods of the present invention, the angular velocity change is recorded between the second and the first angular velocity, that is, the difference is formed by: second angular velocity minus first angular velocity. The increase in velocity, i.e. the angular velocity change, corresponds to the acceleration. As was noted above, the acceleration is able to occur because of an actual velocity increase (or velocity reduction) of the shaft, but also because of a precision error in the transducer wheel.

For this reason, according to the present invention, the second angular velocity is not output directly, for instance, to a regulation, but the output angular velocity, which corresponds to the third angular position, is output together with an artificially decreased angular velocity change, that is, as the first output angular velocity (angular velocity which was output for the previous interval, or rather, for the end of the previous interval), is added to only a portion of the angular velocity change, ascertained using the first and the second angular velocity (and not the complete angular velocity change), so that the output angular velocity coming about does not correspond to the complete second angular velocity, but only to the previously output angular velocity, inclusive of an attenuated portion of the angular velocity change. Particularly, a proportion of the angular velocity change may be zero at the point in time of the third angular position, so that at the point in time of the third angular position the previously output angular velocity, and not the second angular velocity or the previously output angular velocity is output, inclusive of the full angular velocity change. In other words, the second angular velocity is recorded, to be sure, but it is output as an output angular velocity that begins with the previously output angular velocity (=output angular velocity of the previous interval) and, starting from this, which may take into account, in a linearly increasing manner, the proportion of the angular velocity change, by having the proportion of the angular velocity change increase continuously starting from zero. The proportion of the angular velocity change for a subsequent angular interval may never be used completely, but only at a proportion of <1 for addition to the first angular velocity.

The proportion with reference to the end of the angular interval, or the increase in the proportion in the case of a linear curve according to the angular velocity change may be selected in such a way that, at the end of the angular interval, the angular velocity change is not taken into account fully, so that, towards the end of the angular interval, an angular velocity value is provided that lies between the first and the second angular velocity. The angular interval that begins with the third angular position (and thus represents the beginning of the output of the second angular velocity) ends with the recording interval that ends at the recording of a third angular velocity after the recording of the second, or at a point in time which, based on the first, second and third angular position, as well as the associated time durations, has been extrapolated as the end of the subsequent angular velocity recording interval.

Consequently, according to the exemplary embodiments and/or exemplary methods of the present invention, the angular velocity is ascertained between a first and second angular position, i.e. within a first angular interval, as well as a second angular velocity for the subsequent angular interval between the second and a third angular position. The difference coming about between the two angular velocities, that is, the angular velocity change, is output for the second angular interval, starting from the previously output angular velocity (or, in the case of strongly previously occurring normalized or not normalized angular velocity changes, starting from the previously recorded first angular velocity) having an increasing proportion (starting from zero or a low value) of the angular velocity difference, the proportion rising continuously or what may be linearly, and having a slope, for instance, at which the proportion at the beginning of a subsequent angular interval (following the second angular interval) or at the end of the current angular interval is <1, for example 0.1, 0.2, 0.3, 0.5 or 0.7. Instead of a linear increase, any curves of the proportion for the third angular interval may be selected, for instance, a proportional increase having a constant to be added (which fixes the proportion for the beginning of the angular interval), a stair-like increase having several steps, a curve that comes about from the integration of the amount of the angular velocity difference, or the like, it is ensured, however, that the rising proportion of the angular velocity change within the entire angular interval is <1, and thus the proportional angular velocity change is less than the angular velocity change itself, and then imprecisions in the transducer wheel contribute only in small measure to the determination of the angular velocity.

Alternatively, the proportion may also be <1 for only an angular interval section, the angular interval section beginning with the angular interval, but ending before the angular interval. Instead of a first proportional value and an associated slope, the first proportional value referring to the beginning of the angular interval, a second proportional value may be defined in addition, to which the first proportional value is increased rising in monotonic or strictly monotonic fashion, the second proportional value being reached at the end of the angular interval or at the end of the angular interval section. As was noted before, the first proportional value may be approximately zero, whereas the second proportional value is, for instance, approximately 30% or 40%, greater than the first proportional value and <1 (as is also the first proportional value). The proportional value corresponds to the weighting at which the angular velocity change influences the angular velocity that is output.

The proportion itself may be predefined or is a function of the amount of the angular velocity change, in order to ensure that large angular velocity changes which, from a natural point of view, do not (only) originate from imprecisions of the transducer wheel, have an influence corresponding to the output angular velocity. Furthermore, the method described above, for reducing the influence of the angular velocity change, may also be discontinued, in order to make possible a dynamic reaction on actually proceeding acceleration processes by the regulation for angular velocity changes (normalized to the rotational speed), that are greater than a threshold value. According to that, the absolute value of the velocity change may, for example, be compared to a threshold value, at an angular velocity change less than the threshold value only a proportion of the angular velocity change, having a corresponding curve perhaps, having an influence on the angular velocity that is output, whereas upon exceeding the threshold value, the only proportional influence is cancelled and instead, the full angular velocity change is directly (i.e. without a “soft transition”) included at once (i.e. abruptly) into the output angular velocity. In other words, when the angular velocity change is exceeded, instead of the composed angular velocity as described above (i.e. the first angular velocity plus a proportion of the change), the second angular velocity is output directly, that is, directly after its calculation by dividing the angular interval just covered by the appertaining time duration. The angular signal may alternatively be output as the weighted sum of the actually calculated angular velocity (second angular velocity) and the angular velocity whose dynamics have been attenuated as the output angular velocity, as described above, by transferring only a proportion of the angular velocity change. The weighting may be determined according to the amount of the angular velocity change (normalized to the rotational speed or not normalized), so that the weighting of the second original angular velocity gains by the amount of the angular velocity change, and the weighting of the composed angular velocity, i.e. the angular velocity having the angular velocity change only proportionally taken into account, is reduced by the amount of the angular velocity change. A linear model, in the form of y=c0+x*c1, may be used to calculate the weighting, y being the weighting of the actual, second angular velocity change, x representing the absolute amount of the angular velocity change, and c0 and c1 being constants. A model may be used for the weighting of the angular velocity having attenuated dynamics, according to which the two weightings (y) are constant.

Moreover, in general, to reduce unnecessary regulating measures, the curve of the proportion may be provided to be as “smooth” and continuous as possible, in which a curve is used whose derivative with respect to time for the entire angular interval is less than a predetermined threshold value, and whose differentiation with respect to time may be 0 at the beginning or the end of the angular interval section, for instance, an (approximated) arctangent function or an (approximated) cosine function shifted in the direction of the y axis (raised cosine) for 0 . . . Pi. This enables an especially soft cushioning of angular velocity changes, that originate from imprecisions of the transducer wheel. The curve of the proportion may be constructed using software, hardware or a combination thereof and may be given as a look-up table (proportion compared to angular offset within the angular interval). Besides the parameter of the angular offset within the angular interval and the associated proportion, the look-up table may also include the parameter of the amount of the angular velocity change, in order to adjust the curve to the amount of the angular velocity change. Thus, for instance, in the case of a high amount of the angular velocity change, an entry may be used which corresponds to a rapid increase in the proportion to a high proportional value, and in the case of a low amount of the angular velocity change a curve being selected according to which the proportion rises only weakly with the angular offset, and thus ends at a lower proportion. With that, angular velocity changes that are only marginal, are more greatly suppressed than angular velocity changes which are greater in amount, and which require a stronger effect on the regulation (and on the output angular velocity). Basically, a calculation and the use of a look-up table may be combined with an interpolation algorithm, so that only a small number of values within the look-up table is able to be used for a plurality of input values.

In one particularly simple specific embodiment, the output angular velocity is increased or decreased by a counter according to the angular velocity change. The counter increment corresponds to the (whole-number rounded) angular velocity change, that is, the difference of the counter values that have come about in the time recording in the first angular interval and in the second angular interval. The counter increment may be formed by the difference in the counter values divided by a (fixed) proportional factor, whereby the attenuated slope is specified, and/or divided by a recorded instantaneous rotational speed (or a value proportional to it), whereby a normalization to a normalized rotational speed is reached, so as to prevent that the angular velocity changes at high rotational speeds have a greater effect on the output angular velocity than the angular velocity changes at low rotational speeds. Furthermore, before the calculation, the angular velocity (normalized or not normalized) may be compared with a threshold value, as of which the output angular velocity corresponds to the measured (second) angular velocity, and below which the output angular velocity, as was described above, is corrected continuously upwards or downwards at each measuring interval by an increasing proportion of the angular velocity change.

All the angular intervals may lie one after the other, the first angular interval being between a first and a second angular position, the second angular interval between the second and a third angular position, and a subsequent third angular interval being between a third and a fourth angular sensor position that follows immediately thereafter. According to the present invention, after the output, according to the present invention, of the angular velocity, the assignment to the respective angular intervals shifts, so that basically, from an (N)th interval and the associated time duration, and an (N+1)th interval and the associated time duration, the angular velocity change is able to be calculated, which, according to the present invention, is taken into account only as a proportion and, at the beginning, which may have a proportion of 0 during the output of the angular velocity. In the subsequent angular interval (N+2) the angular velocity change is calculated by subtracting the angular velocity which was calculated for the (N+1)th interval, less the angular velocity which was calculated for the (N+2)th angular interval. According to the exemplary embodiments and/or exemplary methods of the present invention, for the subsequent (N+3)th angular interval, the angular velocity of the (N+2)th interval is not output, but rather the angular velocity which starts from the output of the (N+1)th interval (and the associated angular velocity), and which is changeable according to a rising proportion of the angular velocity change compared to the (N+2)th interval.

According to the exemplary embodiments and/or exemplary methods of the present invention, angular position transducers are used which include a plurality of digital sensors, each digital sensor only being able to output two levels (i.e. level 1: marking is present at the sensor, level 2: marking is not present). These sensors may be shifted by an angle corresponding to 360°/k, k being the number of sensors. In one particular specific embodiment, 3 digital sensors are used, which are respectively offset by 120° with respect to one another, the transducer wheel having teeth that are as wide as the gaps that alternate with the teeth, around the circumference. The binary signal generated by the sensors describes, by the position of the slope, the location at which the gap goes over into a tooth, or vice versa, depending on the slope direction. In order to assign the slope time, a time standard may be used, for instance, a timer or a counter (=time standard), which counts continuously and whose counter value is periodically increased at a constant frequency or at a constant clock pulse by the same amount. The counter may periodically be set back, for instance, each time a certain angular position has been reached (e.g. 0°. If a slope of one of the sensors of the angular position transducer rises or falls, the associated counter value is recorded and stored temporarily. From the difference of the counter values, because of the counter frequency or the counter clock pulse, one is able to calculate directly the associated point in time and following from that, the associated time duration.

Basically, the angular marking may, for instance, be optical or magnetic, in this case, the sensor being an optical or a magnetic sensor. The signal feature that establishes the point in time of the time recording may be a crossing at a certain threshold value, for instance, at a zero crossing.

Besides an application within an angular measuring method or an angular ascertainment method, the damping, according to the present invention, of angular velocity step changes generated by time-discrete angular recording is able to be implemented in a method for regulating the angular velocity of a motor, which may be an electric motor, for instance a direct current machine used as a vehicle drive. According to a first alternative, the regulation process itself may remain unmodified, the input size, however, that is, the measuring step of than actual value of the regulating process, being already modified according to the present invention. Consequently, the otherwise usual regulating mechanism assumes an angular velocity whose curve, according to the present invention, has already been freed of (small) angular velocity step changes by damping. According to a second alternative, the actually recorded angular velocities or the angular sensor signals are fed to the control circuit, the actual/setpoint comparison of the control circuit being modified according to the present invention.

According to this modification, within the scope of the comparison to a setpoint value, in order to record the control error and to correct the control accordingly, the actual value is processed according to the method according to the present invention. Owing to this processing, (small) angular velocity changes are not completely reconstructed but are damped, as was shown. In the latter case, the angular position sensor itself or the supply is able to remain unchanged compared to the related art, whereas the damping according to the present invention is provided within the regulating mechanism. According to the first alternative, however, the supplied angular position transducer signal is modified, so that signals that are already “damped”, that have been freed of (smaller) angular velocity step changes reach the regulating algorithm. The linearization of step changes thus takes place either within the actual/setpoint comparison of the regulation, or already within the scope of the ascertainment of the angular velocity.

Furthermore, the exemplary embodiments and/or exemplary methods of the present invention may be implemented using a recording device that is able to be connected to the angular position transducer, and to record from the latter the actually recorded angular signals. The recording device further includes computing devices as well as a time standard, to carry out the method according to the present invention, that is, to smooth out angular velocity step changes, which come about due to time-discrete angular signals, according to the present invention, and to weight angular step changes with a temporally rising proportion. The recording device also includes an output, which outputs a signal smoothed out according to the present invention, that is equivalent to the angular velocity value. Such a recording device may, for instance, be connected between an angular position transducer according to the related art and a regulating device according to the related art, this permitting a modular manner of implementation, and both angular position transducer and regulating circuit being able to remain unchanged. Thus, the modification according to the present invention takes place in a module that is interconnectable.

According to a first specific embodiment, the module itself is able to generate the output angular velocity modified according to the present invention from individual angular position transducer signals, and for this purpose, the recording device including processing units, using which the angular position transducer signals are able to be converted to angular velocities. According to a second design, the device already includes inputs for recording angular velocity values (calculated ahead of time), so that the device has only to calculate the angular velocity change, and to convert this into corresponding values having an increasing proportion part. Depending on the type of angular position transducer used (i.e. with or without preprocessing) the one or the other device may be interconnected between the angular position transducer and the regulating circuit.

Basically, an actually recorded angular velocity, an angular velocity averaged over time or an initial value, especially during starting of the motor, may be used as the output velocity value that is the basis for a subsequent output velocity value. Furthermore, it may be provided to set the (previous) output velocity value, regularly or periodically, to the instantaneously recorded angular velocity, to prevent drifting off. Moreover, as the (preceding) output velocity value, an averaging over time of a plurality of preceding output velocity values may be used.

In summary, the exemplary embodiments and/or exemplary methods of the present invention relates to a method and a device for recording angular velocity using a digital angular position transducer, for controlling an electric motor, for example. Instead of taking into account time-discrete changes directly in the form of step changes in the output signal, the recorded angular velocity change is taken into account only with an (increasing) proportion in the output. This permits a smoother curve in the case of a not completely precise transducer wheel, whose imprecisions would otherwise lead to unnecessary reactions by the regulation. Large angular velocity changes, on the other hand, are passed on directly, so as to take into account accelerations going along with them in an unaffected manner in the regulation.

Exemplary embodiments of the present invention are shown in the drawings and explained in greater detail in the following description.

### BRIEF DESCRIPTION OF THE DRAWINGS

FIG. 1 shows an exemplary curve shape of the output angular velocity according to the present invention, which is compared to a corresponding curve shape according to the related art.

FIG. 2a, FIG. 2b, FIG. 2c, and FIG. 2d show curve shapes according to the present invention, which are compared to respective curve shapes according to the related art.

### DETAILED DESCRIPTION

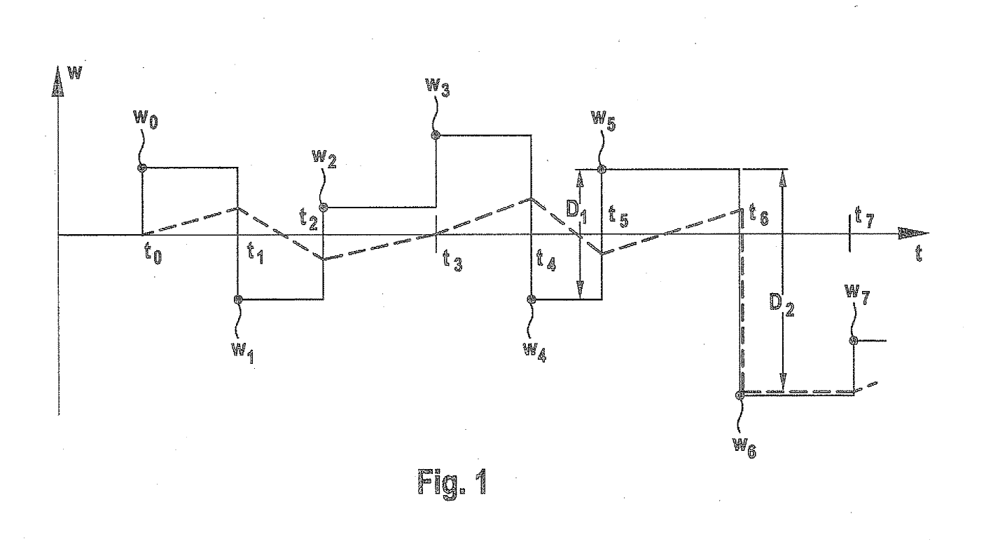

FIG. 1 shows an exemplary curve shape of a recorded angular velocity having a solid line, according to the related art, to which is compared a corresponding angular velocity curve as a dashed line, which comes about upon application of the present invention. In FIG. 1, angular velocity W is plotted against time t. W=dw/dt applies, where w represents the angular position.

At time t₀, a first angular velocity w₀ is determined, so that in the related art (solid line) the output angular velocity immediately rises to the value w₀. At time t₁, a second angular velocity w₁ is recorded, this also immediately and completely influencing the output angular velocity, according to the related art. Consequently, the solid line represents in each case the currently determined angular velocity, until the latter is taken over by an additional, more current angular velocity. According to the exemplary embodiments and/or exemplary methods of the present invention, if, however, at time t₁ a change in the angular velocity from w₀ is recorded, the change is not directly and completely passed on, but as a curve that is added to a preceding output angular velocity value, and which in increasing measure has a proportion of the angular velocity difference between the amplitude of w₀ and w₁. In FIG. 1 the proportion of the angular difference rises linearly, at t₁, however, the proportion being =0 and at t₂ (shortly before the recording of a current velocity value) it being a maximum, but less than 1. That being so, the output angular velocity shown in a dashed line in FIG. 1 does follow the curve of the recorded angular velocity, but not completely or in a linearly increasing measure.

At time t₀, a beginning initial output angular velocity value is assumed, such as a first (or zeroth), (i.e. measured ahead of time) angular velocity. However, at time t₀, a more current, second angular velocity w₀ is recorded, whereby the output angular velocity according to the present invention increases as of time t₀ according to this change, but only proportionally. In other words, the rise between t₀ and t₁ reflects the velocity increase as shown by the slope at t₀, however, the angular velocity change, as characterized by w₀, having only a negligible effect on the output angular velocity, at the beginning of the interval t₀-t₁. The output angular velocity at the beginning of the interval t₀-t₁ is rather determined by the output speed which was output at time t₀, with increasing t, as of t₀, the proportion of the angular difference also increasing linearly, which refers to the angular difference at w₀. For the second time interval t₁-t₂ the output angular velocity, which was output at time t₁ is determining in the same way for the beginning of this second time interval (that is, at t₁ or shortly after t₁), and also in increasing measure, the curve of the output velocity between t₁ and t₂ being determined by the angular velocity change, which is given by the difference between w₁ and w₂.

The slope, dropping off at t₁, of the actually measured angular velocity is thus corrected over the entire interval t₁-t₂, in that the angular velocity change at first does not influence the output angular velocity, and then, with increasing time lapse, is added with a linearly increasing proportion to the output angular velocity at t₁. It may be seen that at time t₂ the proportion of the angular velocity change is clearly less than 1, since the amplitude difference between w₁ and w₀ was only added in a proportion to the output angular velocity at t₁, the proportional factor in FIG. 1 being approximately 40%. In other words, the amplitude difference between the output angular velocity at t₁ and the output angular velocity at t₂ corresponds to 40% of the amplitude difference that is given as a slope at t₁, i.e. w₁-w₀. In other words, the output angular velocity at the end of the respective interval corresponds to 40% of the recorded angular velocity change, and, within this interval, 0-40%, this proportion being a linear function of the time when the beginning of the interval is selected as the time null point. As was observed before, the proportional curve, and particularly the proportion to be reached maximally, is able to be a function of the recorded angular velocity change.

The angular velocity change between t₄ and t₅ (cf. slope at t₅ having the angular velocity change of w₅ minus w₄) leads to a rise in the output angular velocity from a value at t₅ (which corresponds to the output angular velocity at the end of the preceding interval), which rises to a value at t₆ because the slope from t₄ to t₅ is added in an increasing measure to the output angular velocity at the end of interval t₄-t₅. Time interval t₅-t₆ thus reflects in increasing measure the angular velocity change given as D₁ between w₄ and w₅.

However, at time t₆ an additional angular velocity is recorded, which leads to an angular velocity change D₂ (=w₆-w₅). According to one particular embodiment of the present invention, all the recorded angular velocity changes, which may be before setting up the output angular velocity, are compared, with respect to their amount, to a threshold value, and, as of a certain threshold value, the basis is not a previous output angular velocity and an increasing proportion of an angular velocity change, but rather the output angular velocity is directly (or only slightly delayed) set equal to the second recorded angular velocity.

On the assumption that, between t₀ and t₆, all fluctuations of the recorded angular velocity are to be attributed to imprecisions of the transducer wheel, it is meaningful that, for these time intervals, the output angular velocity represents the angular velocity change not completely and only proportionally. If, however, at t₆ there occurs an angular velocity change which, because of its greater amount (which is greater than the amount of change in previous intervals, and is greater than a threshold value) is to be attributed to a velocity change of the shaft that is actually to be taken into account, then the output angular velocity is set equal to the newly recorded angular velocity, so that a controller starting from the output angular velocity is able to convert this change directly and undamped in control mechanisms. Because of that, for significant angular velocity changes, high dynamics remain ensured in the regulation.

One may see that all the successively recorded angular velocities differ by an amount that is small compared to the amount of D₂. A threshold value lying barely below D₂, that is, a threshold value that lies between D₂ and (w₄ minus w₃), thus makes possible ending the damping according to the present invention of small angular fluctuations, and enables the reaction of the controller to large angular velocity changes. For time interval t₆-t₇ the damping according to the present invention is thus suspended, and the output angular velocity corresponds exactly to the difference between the two precedingly measured angular velocities. In comparison to the angular difference between w₆ and w₅ (and above all in comparison to a corresponding threshold value), the difference between w₇ and w₆ turns out to be clearly smaller, so that as of time w₇, transition may occur again into the “damped” reaction mode, at which the output angular velocity (=w₆), that prevailed shortly before w₇, is taken as the basis, to which a proportion of the angular velocity change w₇ w₆, starting at 0 and increasing, is added until a maximum proportion is reached (that is less than 1). The output angular velocity that is to be provided beginning at w₇ thus has the triangular shape or ramp shape as is shown by the dashed line between t₀ and t₆. Based on the reference to the angular velocity, the increase of the ramp before t₆ and after t₇ is proportional to the angular velocity change recorded in the preceding interval.

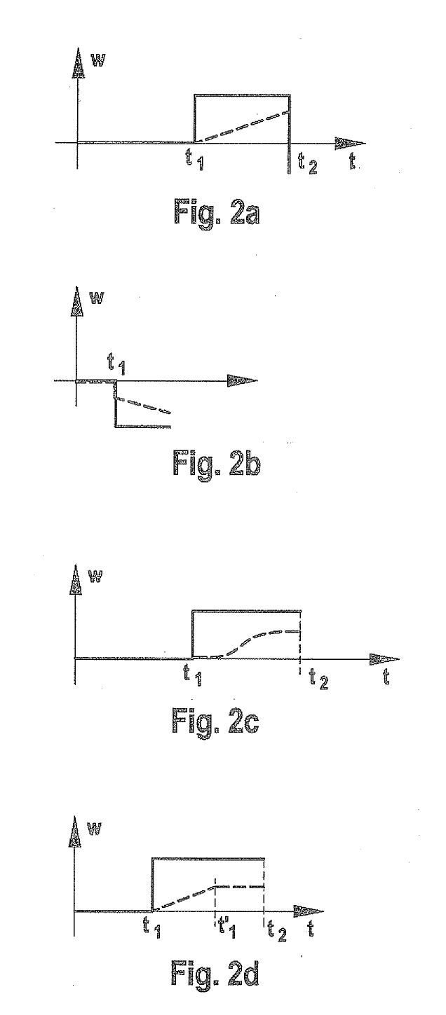

FIG. 2a, in a solid line, shows the angular velocity recorded and also output according to the related art, the actually output output angular velocity according to the present invention being shown by a dashed line. One may see that the angular difference at time t₁ is added, first at a proportion of 0, and then increasingly up to a maximum proportion at time t₂, to the preceding output angular velocity (in this case=first angular velocity).

FIG. 2b shows a curve of the output angular velocity, shown in a dashed line, in reaction to a rise at t₁, the proportion of the angular velocity change, already at time t₁ (i.e. at the beginning of the interval) not being 0, but rather corresponding to a first proportion greater than 0 and less than 1. However, in addition, the proportion increases with increasing time beginning at t₁, linearly, for example, in order to reconstruct the actually recorded angular velocity change more precisely. To be sure, the incomplete damping at time t₁, shown in FIG. 2b, does not suppress precision-conditioned fluctuations completely, but the curve shown in FIG. 2b permits an early adaptation to necessary control changes, even if these are partially overshadowed by errors in precision.

FIG. 2c shows a nonlinear proportion curve which, the same as in FIG. 2a, is equal to 0 at time t₁, which, however, beginning at this point, shows a nonlinear but “softer” curve, which leads to a maximum proportion <1. The differentiation with respect to time, of the curve over time shown in FIG. 2c, compared to the curves shown in FIGS. 2a and 2b, is equal to 0 at the beginning of the interval starting at t₁ and rises strictly monotonically, so that the associated controller reaction leads to smaller current peaks during the regulation. In the same way, the proportion does not rise any more toward the end of the interval t₁-t₂, so that the derivative with respect to time is also equal to 0 at t₂. By such soft transitions it may be avoided that abrupt control changes are undertaken in a controller having high dynamics.

The curve shown in FIG. 2 is able to correspond to an arctangent, a cosine curve between 0 and n, or a similar curve, whose first derivative tends to 0 at the beginning and at the end.

FIG. 2d shows a curve in which the proportion at time t₁ is 0, however, it does not rise any more as of time t₁′ but remains constant. Between time t₁ and t₁′, the proportion rises continuously, starting from a proportion equal to 0. Beginning at time t₁, the proportion remains at a constant level greater than 0 (but less than 1). As was noted before, the output angular velocity shown by a dashed line in FIG. 2d, relates to the step change at t₁, that is, to the angular velocity change determined at t₁. In comparison to FIGS. 1 and 2a-2c, FIG. 2d shows an increasing proportion curve only for a first interval section, which begins with the interval itself, but ends before the interval (at t₁′). The interval itself ends at t₂.

1-10. (canceled)

11. A method for recording an angular velocity of a motor shaft, the method comprising:
providing an angular signal of a time-discrete angular position transducer that reproduces points in time, at which the angular position of the motor shaft of an angle sensor position corresponds to a plurality of predetermined angle sensor positions;
recording the points in time at which a first, second and third angle sensor position occur which are provided in this sequence one after the other;
ascertaining a first angular velocity by determining the ratio of the angular differences between the first and the second angle sensor position, and the time duration between the points in time of the first and the second angle sensor position;
ascertaining a second angular velocity by determining the ratio of the angular difference between the second and the third angle sensor position, and the time duration between the points in time of the second and the third angle sensor position;
ascertaining an angular velocity change between the second and the first angular velocity; and
providing an output angular velocity that is assigned to the third angular position, as a sum of an output angular velocity which is assigned to the second angular position, and a proportion of the angular velocity change that is less than the angular velocity change.

12. The method of claim 11, wherein the proportion of the angular velocity change for the output angular velocity, which is assigned to the third angular position, is proportional to a difference between the angular velocity change and a predetermined threshold value, zero for an angular velocity change that is not greater than a predetermined threshold value and corresponds to a predetermined proportion value of one or less than one for angular velocity changes that are greater than a predetermined threshold value, or independently of the absolute amount of the angular velocity change is equal to zero.

13. The method of claim 11, wherein the output angular velocity for an angular interval is provided, which begins with the third angular position, and, during the at least one angular interval section, beginning with the third angular position, the output angular velocity is provided as the sum of the output angular velocity that is assigned to the second angular position, and a rising proportion of the angular velocity change is provided, which within the entire angular interval or angular interval section is less than the angular velocity change.

14. The method of claim 13, wherein, during the angular interval section, the proportion of the angular velocity change is increased, starting from a first proportion value, rising monotonically or strictly monotonically to a second proportion value, which is greater than the first proportion value, and which is less than one.

15. The method of claim 13, wherein the proportion is increased during the angular interval section according to a predetermined curve; rises linearly to a constant or to a proportion of the angular velocity change as a function of the absolute amount of the angular velocity change to less than one; rises according to a curve whose derivative with respect to time is less than a predetermined threshold value for the entire angular interval section, whose derivative with respect to time is zero at the beginning or at the end of the angular interval section and rises strictly monotonically during the angular interval section which is one at the end of the angular interval section, or which has a combination of these curve features.

16. The method of claim 13, wherein the angular interval section or the angular interval has an end which corresponds to a fourth angle sensor position of the plurality of angle sensor positions, which lies after the third angle sensor position.

17. The method of claim 11, wherein the angle sensor positions of the plurality of angular positions correspond to directly successive angular positions which are given by the uniform subdivision of an entire revolution by a whole number N.

18. A method for regulating an angular velocity of the motor shaft of a motor, the method comprising:
recording an angular velocity of a motor shaft by performing the following:
providing an angular signal of a time-discrete angular position transducer that reproduces points in time, at which the angular position of the motor shaft of an angle sensor position corresponds to a plurality of predetermined angle sensor positions;
recording the points in time at which a first, second and third angle sensor position occur which are provided in this sequence one after the other;
ascertaining a first angular velocity by determining the ratio of the angular differences between the first and the second angle sensor position, and the time duration between the points in time of the first and the second angle sensor position;
ascertaining a second angular velocity by determining the ratio of the angular difference between the second and the third angle sensor position, and the time duration between the points in time of the second and the third angle sensor position;
ascertaining an angular velocity change between the second and the first angular velocity; and
providing an output angular velocity that is assigned to the third angular position, as a sum of an output angular velocity which is assigned to the second angular position, and a proportion of the angular velocity change that is less than the angular velocity change; and
regulating the motor according to the setpoint angular velocity and regulating the output angular velocity as an input variable;
wherein the regulating includes comparing setpoint and actual values, and wherein the regulating includes ascertaining an angular velocity change and providing the output angular velocity as an actual angular velocity.

19. A recording device for recording the angular velocity of a motor shaft, comprising:
an input that is equipped to be connected to an angular position transducer and to receive an angle signal that reproduces points in time at which the angular position of the motor shaft corresponds to an angle sensor position of a plurality of predetermined angle sensor positions;
a time standard that is connected to the input and generates time values, which correspond to points in time at which a first, second and third angle sensor position occur;
an angle subtraction unit, which is connected to the input and which ascertains the angular difference between the first and the second angle sensor position and the angular difference between the second and the third angle sensor position;
a time subtraction unit which is connected to the time standard, and which ascertains the time duration between the points in time of the first and the second angle sensor position as well as the time duration between the points in time of the second and the third angle sensor position;
a first division unit, which is connected to the angle subtraction unit and the time subtraction unit, and which ascertains a first angular velocity as the ratio of the angular difference between the first and the second angle sensor position to the time duration between the first and the second angle sensor position; and which also ascertains a second angular velocity as the ratio of the angular difference between the second and the third angle sensor position to the time duration between the second and the third angle sensor position;
an angular velocity subtraction unit, which subtracts the second angular velocity from the first angular velocity; and
a smoothing device which forms a sum of an output angular velocity value, which is assigned to the second angle sensor position, and a proportion of the angular velocity change, the proportion being less than the angular velocity change.

20. A device for determining an angular velocity, comprising:
an input for recording a time-discrete angular velocity signal;
an output for outputting a corrected angular velocity signal; and
a processor for subtracting a second angular velocity value from a first, preceding angular velocity value of the time-discrete angular velocity signal from each other, to record an angular velocity change, and to generate an angular velocity end value from the first angular velocity value and the angular velocity change, the output velocity value corresponding to the sum of a directly preceding output velocity value of the first angular velocity value and a proportion of the angular velocity change of less than one; and
a signal generator to output an angular velocity by starting with the preceding output velocity value and rising monotonically to an angular velocity end value.
